(19) United States
(12) Patent Application Publication
(10) Pub. No.: US 2013/0116831 A1
(43) Pub. Date: May 9, 2013

(54) WIND AND POWER FORECASTING USING LIDAR DISTANCEWIND SENSOR

(71) Applicants: Philip L. Rogers, Hume, VA (US); Frederick C. Belen, JR., Oak Hill, VA (US)

(72) Inventors: Philip L. Rogers, Hume, VA (US); Frederick C. Belen, JR., Oak Hill, VA (US)

(73) Assignee: BLUESCOUT TECHNOLOGIES, INC., Chantilly, VA (US)

(21) Appl. No.: 13/620,577

(22) Filed: Sep. 14, 2012

Related U.S. Application Data
(63) Continuation of application No. 13/057,120, filed on May 4, 2011.

(51) Int. Cl. G01P 5/26; G06F 17/00; G05B 13/02

(52) U.S. Cl. CPC G01P 5/26; G05B 13/0205; G06F 17/00
USPC 700/275; 702/3

(57) ABSTRACT

A wind turbine power management system and method includes one or more wind turbines at a wind farm and one or more laser sources used to measure wind conditions remote from the wind farm. The laser sources may be collocated with the wind turbines, and are able to measure wind conditions at various predetermined ranges from the wind turbines. The laser sources measure wind conditions at locations that provide 10 to 20 seconds of advance notice, and also at locations that provide 50 to 100 seconds of advance notice. Wind condition at locations that provide 500 or more seconds of advance notice are also measured using remote laser sources.

### BACKGROUND

The disclosure relates to forecasting wind velocities and in particular to using laser Doppler velocimeters to forecast wind velocities for wind turbine power output management and effective integration into the electrical grid of wind-generated power.

Wind turbines harness the energy of the wind to rotate turbine blades. The blade rotation is used to generate electric power. The generated power is accessible by consumers via a power grid, generally controlled by a utility company. However, because wind velocities constantly change, using a wind turbine or multiple wind turbines in a wind farm to generate a constant power supply for the power grid requires adapting the operation of the wind turbine to the changing conditions of the wind. When an entire wind farm of turbines is used to generate power for the power grid, each turbine must be adaptively controlled in order to respond to the changing wind conditions.

Currently, wind turbines are adaptively controlled and wind farm power output is predicted based on daily or other relatively long-term weather forecasts. Such forecasts estimate future wind velocities based on predictive models involving isobars or pressure gradients. However, these forecasts lack the accuracy and timeliness required to account for minute-by-minute or even hourly local or regional fluctuations in wind velocity which are critical in wind energy production. Wind turbines may also be adaptively controlled based on wind conditions measured at a meteorlogical station or tower. However, such stations are expensive and only measure wind conditions at the location of the station. Thus, such stations do not provide enough information to effectively control an array of wind turbines at a wind farm which is located remotely from the meteorlogical station. Specifically, the sparse placement of meteorlogical stations fails to provide sufficient information to effectively map and predict wind conditions as they approach a wind farm.

One of the most significant costs associated with harnessing wind power results from these inaccurate forecasts of wind generation. Because the electrical grid requires that electrical generation and consumption remain in balance in order to maintain stability, the unpredicted short-term variability of wind velocities can present substantial challenges to incorporating large amounts of wind power into the electrical grid system. Changes and interruptions in the amount of electricity produced through wind power result in increased costs for regulating the electrical supply and maintaining adequate incremental operating reserves. For example, when wind-generated electricity levels are higher than anticipated, an accompanying increase in energy demand management efforts must occur, including load shedding or storage solutions. Alternatively, when wind-generated electricity levels are lower than anticipated, a sufficient reserve capacity must be maintained that can be quickly brought on-line for those instances. Wind power can be replaced by other power stations during low wind periods, however this increases costs and requires that systems with large wind capacity components include more spinning reserve (plants operating at less than full load). Moreover, the above-described short-comings of the current wind velocity measurement techniques do not allow wind farms to accurately forecast power output levels until it is too late. As a result, replacing power that was expected to be generated by a wind farm with these other sources becomes much more expensive and a potential road-block to increasing the percentage of renewable energy integration.

Additionally, failure to adequately adjust direction and/or orientation of wind turbines in response to short-term variations in wind velocity can result in substantial stresses being applied to the turbines themselves. Sudden increases or decreases in load can damage or significantly reduce the expected lifespan or load capacity of a turbine. The resulting repair and maintenance costs and associated down-time are very detrimental to wind farm profitability and viability.

As a result of these concerns, many wind farms are operated at 30% or more below operating capacity, thus reducing the total amount of fluctuating power that must be compensated for should wind conditions change unexpectedly. For all of these reasons, there exists a desire and need to accurately forecast wind conditions at a wind farm well in advance of the wind actually reaching the wind farm so as to provide enough time to adaptively regulate the wind turbines to optimize electric power generation, minimize maintenance and repair costs, and also to enable the wind farms to notify electrical utilities in advance of any expected power output changes. Measured wind data from a number of sites can be networked together into a regional or larger real time wind picture. Such a data base supports larger scale power management decisions and reduces risk and uncertainty in maintaining grid capacity and stability under variable loads.

### BRIEF DESCRIPTION OF THE DRAWINGS

FIG. 1 illustrates a wind farm with LDV.

FIG. 2 illustrates a wind vector map for the wind farm of FIG. 1.

FIG. 3 illustrates a regional wind vector map.

FIG. 4 illustrates an advance notice time line for wind turbine and electrical grid adjustment.

### DETAILED DESCRIPTION

A laser Doppler velocimeter (“LDV”) may be used to determine wind speeds at target regions remote from the velocimeter. The LDV uses LIDAR technology. LIDAR, which stands for “light detection and ranging,” is an optical remote sensing technology that measures properties of scattered light to find range and other information of a distant target. For example, an LDV may be used to transmit light to a target region in the atmosphere. Objects at the target region such as aerosols or air molecules act to scatter and reflect the transmitted light. The LDV then receives the reflected light from the target region. This received light is processed by the LDV to obtain the Doppler frequency shift, f_{D}. The LDV then conveys the velocity of the target relative to the LDV, v, by the relationship v=(0.5)cf_{D}/fₜ where fₜ is the frequency of the transmitted light, and c is the speed of light.

Through the use of LIDAR technology, wind conditions may be accurately measured using an LDV that is remote from the target region. For wind turbines, this means that a single LDV could be used to measure wind conditions at multiple locations, including at locations far away from the wind turbine. By using range-gating techniques, an LDV could make measurements at locations far from the wind turbine as well as at intermediate distances, thus providing a means to track the approach of a wind front as it passes over the surrounding terrain. Multiple LDVs could be used, thus increasing the range of measured locations and the resolution of collected data within the measured area.

Target regions are selected such that wind velocity measurements at those regions will allow for sufficient time to adapt the wind turbines at the wind farm to account for any changes in wind velocity. Additional target regions may be selected that provide additional time for balancing load on an electric grid associated with the wind farm, thereby allowing the powering-up or down of additional power sources in order to compensate for changes in power generated by the wind farm. Through using a network of LIDAR devices, operators of wind farms will gain anywhere from hundreds of seconds to ten or more minutes of advance notice regarding incoming wind velocities.

Therefore, the invention provides a system and method for measuring wind conditions at ranges of several kilometers in any direction from a wind farm. With the resultant lead-time, a wind farm operator and an associated area power coordinator can manage variability, storage, and on- or off-line reserve power sources to maintain balance with load. The wind farm operator is also able to use the collected wind condition data to take actions to prevent wind overloads from overstressing the wind turbine structures or prematurely fatiguing expensive components such as blades and drive train. The profitability of wind energy depends strongly on minimizing repair and maintenance down-time and costs. Given the complex bidding and penalty structure of the power market, advance knowledge of the wind and, therefore, potential power data becomes very valuable to the operator.

In an embodiment of the disclosure, the invention includes one or more LIDAR-based sensors designed to provide data on remote wind direction and magnitude from virtually any location. The sensor is capable of accuracy of better than 1 m/s of wind speed and 1 degree of wind direction regardless of range. The maximum range of the sensor could vary according to needs by simply adjusting several design parameters such as laser power, pulse characteristics, data update rates and aperture size.

An example of a preferred LIDAR-based sensor is disclosed in U.S. Pat. No. 5,272,513, which is incorporated by reference herein. Another example of a preferred LIDAR-based sensor is disclosed in International Application No. PCT/US2008/005515, also incorporated by reference herein. The disclosed LDV is fully eye-safe and uses all fiber-technology. The LDV may be directed in a single direction, or could have multiple transceivers directed in multiple directions. Alternatively, the LDV could include means to rotate the transceivers so that measurements may be made in any direction. Mirrors could also be used to direct transmissions from a stationary transceiver in any direction.

While near field measurements may be useful, the LDV is also capable of determining wind conditions at distances of one or more kilometers. The LDV sensors may be located on wind turbines at a wind farm, or on other stationary objects at or near the wind farm. Additionally, remotely-located LDV sensors may also be used to produce a more expansive map of wind conditions. By using both local and remote LIDAR sensors, a combination of micro and macro-scaled wind mappings may be generated.

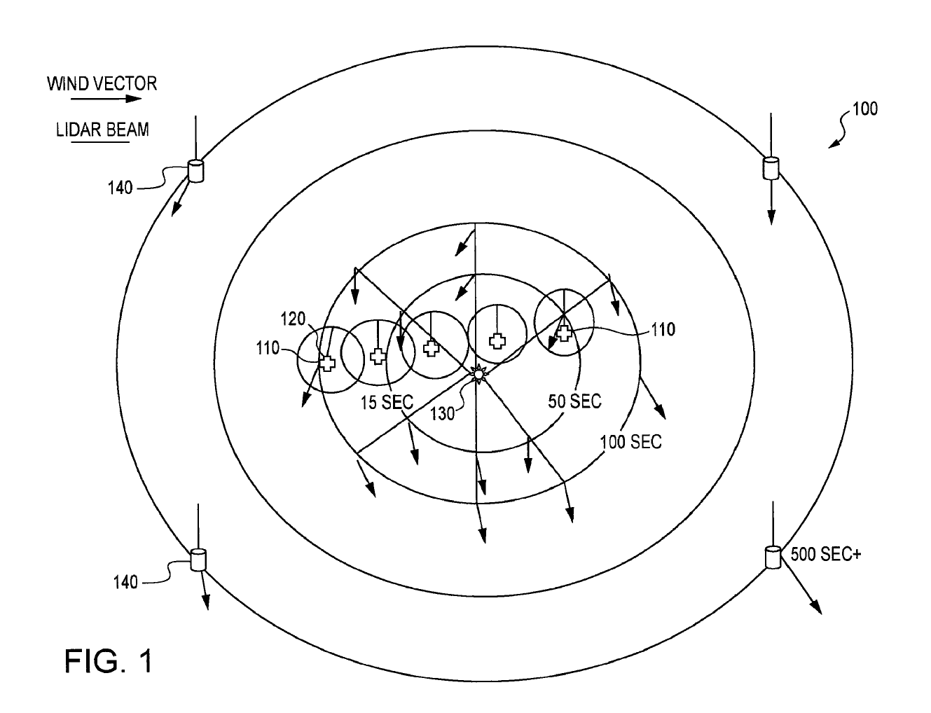

FIG. 1 illustrates one embodiment of the disclosure. In FIG. 1, a wind farm 100 is illustrated. The wind farm 100 includes one or more wind turbines 110. Many of the wind turbines 110 also include an LDV 120 capable of determining wind conditions in the near range. The near range includes measurements of wind conditions at locations 200 to 400 meters away from the LDV 120. For an average wind of 20 m/s, these measurements result in 10 to 20 seconds of advance notice before the measured wind arrives at the turbine 110. In FIG. 1, a near-range of 15 seconds is shown. In addition to the near range LDVs 120, the wind farm 100 also includes one or more long range LDVs 130. The long range LDVs 130 are capable of making measurements in any direction. The long range LDVs 130 have a range of 1 to 2 kilometers. Again, assuming an average wind speed of 20 m/s, these measurements result in 50 to 100 seconds of advance notice before the measured wind arrives at the wind farm 100.

If desired, additional measurements may be made that are even more distant from the wind farm 100. Conceivably, these measurements could be made by a very long range LDV. Or, alternatively, and as illustrated in FIG. 1, these far afield measurements may be made using remotely located LDVs 140. These LDVs 140 are located so that measurements made using the LDVs 140 are 10 or more kilometers from the wind farm 100. A wind condition measurement made 10 kilometers from the wind farm 100 would provide advance notice of at least 500 seconds (more than 8 minutes), assuming an average wind speed of 20 m/s. Clearly, through appropriate LDV placement, additional measurements may be taken.

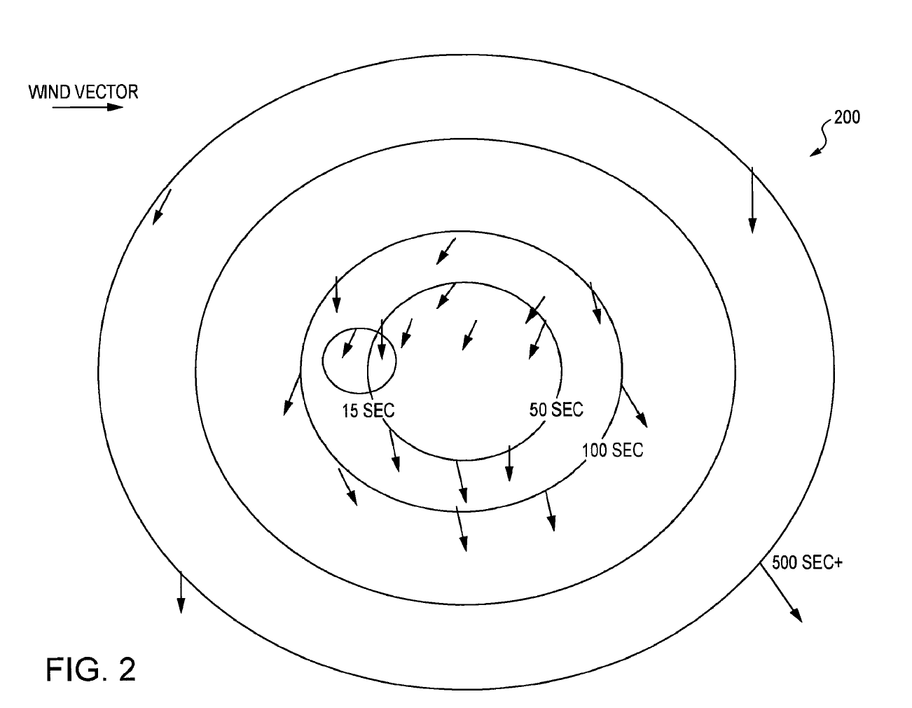

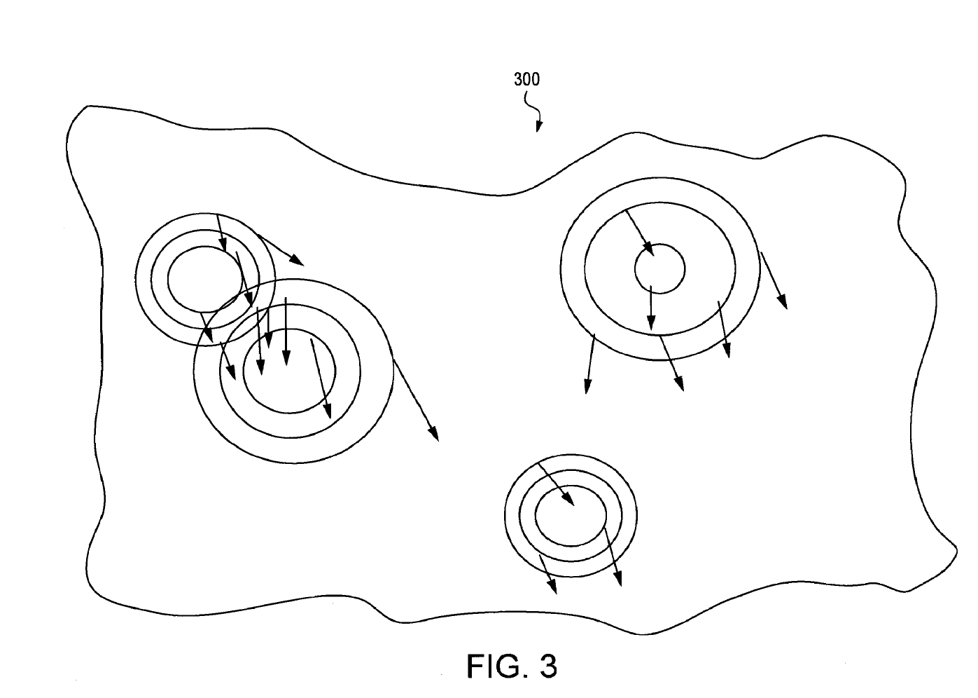

The resulting measurements may be illustrated on a wind vector map 200, as illustrated in FIG. 2. The map 200 includes wind velocities (speeds and directions) for each measured target region. The map 200 could be updated frequently, including several times a minute, or as frequently as measurements were made. The map 200 could be used to determine adjustments that must be made to wind turbines at the wind farm as well as any local or regional adjustments that must be made in order to maintain a stable power grid.

As additional LDVs are established and additional measurements are made, the wind vector map could be enlarged in both scope and resolution. FIG. 3 illustrates a regional wind vector map 300. In the map 300, multiple LDV groupings are used to create a map 300 that includes instantaneous wind condition data throughout the region.

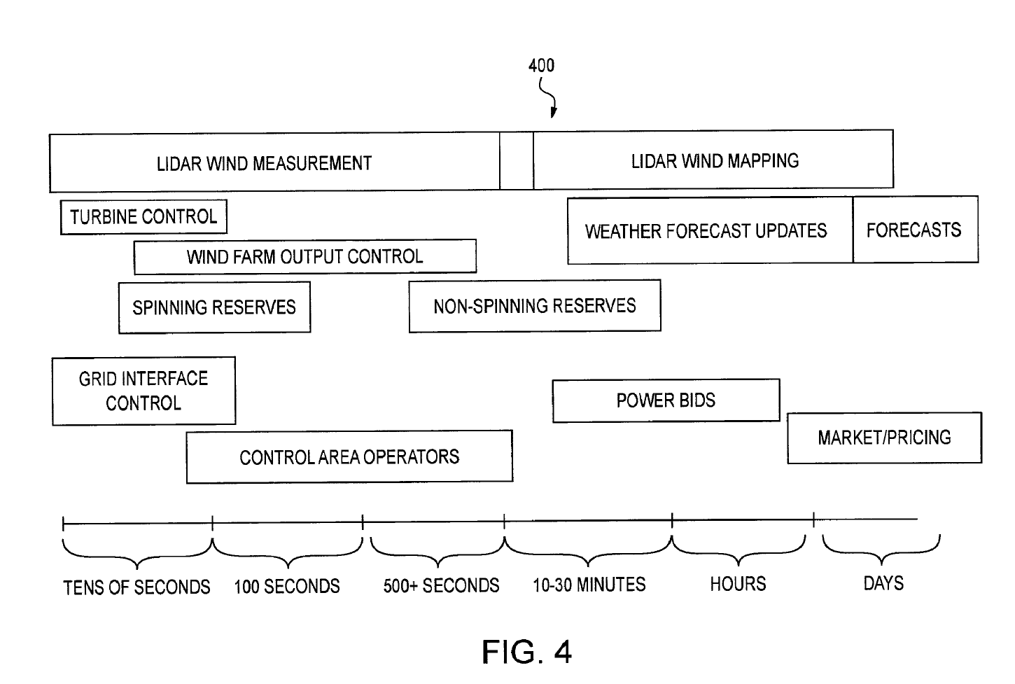

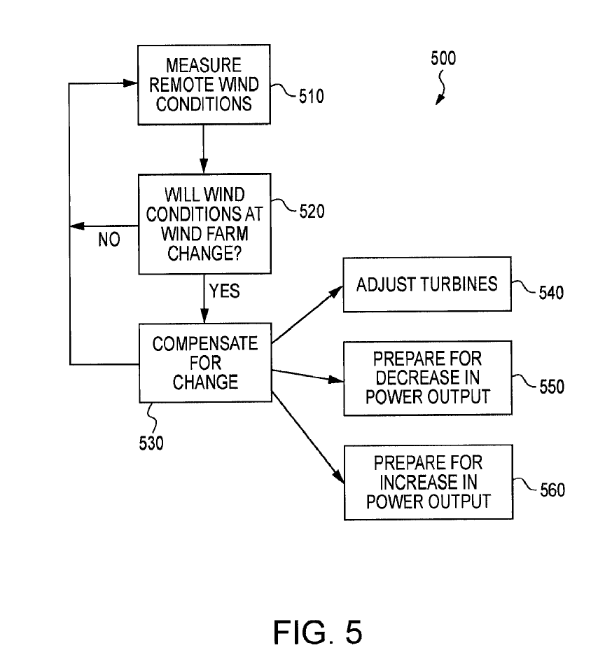

The wind vector maps 200, 300 and the measured wind conditions are used in order to make necessary adjustments at both the wind farm and in the regional power grid. For example, FIG. 4 illustrates a time line 400 that shows how much advance notice is desired in order to make specific types of adjustments. Using the disclosed embodiments, LIDAR wind measurements can be used with a feedback system to control turbines and manage power output using measurements that provide anywhere from tens of seconds of advance notice to 500 or more seconds of advance notice.

With advance notice of tens of seconds, turbines can be adjusted in order to maintain stable wind loads. By maintaining constant loads within specified operating parameters, wind farm operators can minimize the wear and stress on their turbines. Turbines are adjusted not only to harness the wind but also to avoid sudden changes in load that often result in turbine damage. An advance notice of tens of seconds is also enough time for a wind farm operator to interface with the connecting power grid to give a warning that a power output change is imminent.

Advance notice of tens of seconds to hundreds of seconds is necessary in order to bring spinning reserves on- or off-line. It is also enough time to effectively control the wind farm output so that the output is as stable as possible. With hundreds of seconds of advance notice, area operators are able to adjust the local power grid in order to absorb the changing output from the wind farm.

With 500 or more seconds of advance notice, other power sources including non-spinning power reserves are able to be brought online. And with even more advance notice, as provided by the regional wind vector map 300, for example, the LIDAR wind mapping may be used to update weather forecasts and influence bidding and pricing of the electrical grid markets.

A simplified illustration of the disclosed feedback system is illustrated in FIG. 5. In method 500 of FIG. 5, wind condition measurements are made (step 510) using one or more laser Doppler velocimeter, as illustrated in FIG. 1. Using the measured wind conditions, a determination is made regarding whether arriving wind conditions are different than current wind conditions (step 520). If there is no change in the conditions, no change need be made at the wind farm or on an associated power grid. However, if there is a change in arriving wind conditions, compensating activities must occur (step 530). One compensation activity includes adjusting individual wind turbines to maintain a constant load on the turbines (step 540). This also can result in a constant power output from the wind farm. Another compensation activity includes notifying the power grid utilities of an expected decrease in power output from the wind farm (step 550). Still an additional compensation activity includes notifying the power grid utilities of an expected increase in power output from the wind farm (step 560). These notifications result in actions that allow the total power available on the power grid to remain constant, despite changes in power output from the wind farm. Regardless of whether compensating activities occur, further measurements are made to evaluate future time periods.

Therefore, by using LIDAR to solve the wind intermittency problem, many problems are eliminated. Remote wind measurement at various ranges can provide real time conditions from 10 to 500+ seconds before the conditions arrive at the wind farm. This allows for wind mapping and change tracking. It also allows for very accurate power variation projections. It allows for reaction times sufficient for grid balancing, maintaining stability, power bidding, power ramping, application of reserves or other farm and grid management actions. Thus, the reliable wind data leads to lower costs, higher turbine utilization, and more reliable grid operation.

1. (canceled)

2. A method, comprising:
measuring wind conditions at a first range with respect to a wind farm using at least one laser Doppler velocimeter coupled to a wind turbine, wherein the first range is between a first distance and a second distance from the wind turbine; and
measuring wind conditions at a second range that is between a third distance and a fourth distance from the wind turbine, wherein the first range and the second range do not overlap; and
determining an expected output power level to be transmitted to a power utility from the wind farm based at least on the measured wind conditions at the first range and the second range.

3. The method of claim 2, wherein the first distance is 200 meters, the second distance is 400 meters, the third distance is 1 kilometer, and the fourth distance is 2 kilometers.

4. The method of claim 2, further comprising:
determining, from the measured wind conditions and the expected output power level, when the wind farm is unable to generate a threshold output power level; and
transmitting a message to the power utility to use additional power sources.

5. The method of claim 2, further comprising:
determining, from the measured wind conditions and the expected output power level, when the wind farm will generate more than a threshold output power level; and
transmitting a message to the power utility to store power generated by the wind farm in excess of the threshold output power level or to discontinue use of additional power sources.

6. The method of claim 2, further comprising adjusting a wind turbine on the wind farm, based on the measured wind conditions, to maintain a stable load on the wind turbine.

7. The method of claim 2, wherein the plurality of laser Doppler velocimeters have a 360-degree field of rotation.

8. The method of claim 2, wherein the wind farm comprises a plurality of wind turbines.

9. The method of claim 2, further comprising transmitting a notification to the power utility regarding the determined expected output power level.

10. The method of claim 2, further comprising:
generating a wind vector map from the measured wind conditions; and
transmitting the wind vector map to update a weather forecast.

11. The method of claim 2, further comprising measuring the wind conditions at various ranges from the wind farm with the plurality of laser Doppler velocimeters.

12. The method of claim 11, wherein the wind conditions are measured about 200 meters to 2 kilometers from the wind farm.

13. The method of claim 11, wherein the wind conditions are measured to provide about 10 to 500 seconds advance notice of the wind conditions before the wind conditions arrive at the wind farm.

14. The method of claim 11, further comprising measuring the wind conditions at least about 500 seconds from the wind farm.

15. The method of claim 2, wherein the power utility is remotely located from the wind farm.

16. The method of claim 15, wherein the power utility is remotely located from the wind farm.

17. The method of claim 2, wherein the plurality of laser Doppler velocimeters are disposed along a remote periphery around the wind farm.

18. The method of claim 17, wherein the plurality of laser Doppler velocimeters comprise at least four laser Doppler velocimeters disposed along the remote periphery.

19. A method, comprising:
measuring wind conditions at a first range from a wind turbine using at least one laser Doppler velocimeter; and
measuring wind conditions at a second range from the wind turbine, wherein the first range and the second range do not overlap; and
determining an expected output power level to be transmitted to a power utility from the wind farm based at least on the measured wind conditions at the first range and the second range.

20. The method of claim 19, wherein the first range is between 200 meters and 400 meters and the second range is between 1 kilometer and 2 kilometers.
